(19) United States
(12) Patent Application Publication
(10) Pub. No.: US 2025/0260031 A1
(43) Pub. Date: Aug. 14, 2025

(54) FUEL CELL SYSTEM

(71) Applicant: Honda Motor Co., Ltd., Tokyo (JP)

(72) Inventors: Kotofumi Yanai, Saitama (JP); Kiyohide Hibino, Saitama (JP)

(21) Appl. No.: 19/045,475

(22) Filed: Feb. 4, 2025

(30) Foreign Application Priority Data
Feb. 8, 2024 (JP) 2024-017839

(51) Int. Cl. H01M 8/04225; B60L 50/70; H01M 8/04223; H01M 8/0432; H01M 8/04492; H01M 8/04858

(52) U.S. Cl. CPC H01M 8/04225; B60L 50/70; H01M 8/04268; H01M 8/0432; H01M 8/04492; H01M 8/0491

(57) ABSTRACT

A fuel cell system, includes: a fuel cell stack configured by stacking a power generation cell including an electrolyte membrane and an electrode; a temperature sensor configured to detect a stack temperature of the fuel cell stack; a current limiting circuit configured to limit an output current output from the fuel cell stack to a limit value or less; and an electronic control unit. The electronic control unit: executes warm-up of the fuel cell stack at time of low-temperature startup in which the fuel cell stack is started from a predetermined low-temperature state; estimates a water content of the power generation cell; sets the limit value based on the stack temperature and the water content; and controls the current limiting circuit to limit the output current to the limit value or less after the warm-up is completed.

### CROSS-REFERENCE TO RELATED APPLICATION

This application is based upon and claims the benefit of priority from Japanese Patent Application No. 2024-017839 filed on Feb. 8, 2024, the content of which is incorporated herein by reference.

### BACKGROUND OF THE INVENTION

### Field of the Invention

The present invention relates to a fuel cell system.

### Description of the Related Art

Use of a fuel cell as a drive source of a vehicle or the like can contribute to improvement of energy efficiency. As a technique related to such a fuel cell, conventionally, a device configured to limit an output current from a fuel cell stack when the stack is started under a low temperature environment is known. For example, in the device described in JP2015-228305 A, a first limit value is calculated on the basis of the internal average temperature of the stack, a second limit value is calculated on the basis of the impedance resistance value of the stack, and the output current is limited to the smaller one of the first limit value and the second limit value until the warm-up of the stack is completed.

However, merely limiting the output current during the warm-up of the stack, as in the device described in JP2015-228305 A, may result in decrease in an output voltage from the stack due to flooding when a relatively large output is required immediately after completion of warm-up.

### SUMMARY OF THE INVENTION

An aspect of the present invention is a fuel cell system, including: a fuel cell stack configured by stacking a power generation cell including an electrolyte membrane and an electrode; a temperature sensor configured to detect a stack temperature of the fuel cell stack; a current limiting circuit configured to limit an output current output from the fuel cell stack to a limit value or less; and an electronic control unit. The electronic control unit: executes warm-up of the fuel cell stack at time of low-temperature startup in which the fuel cell stack is started from a predetermined low-temperature state; estimates a water content of the power generation cell; sets the limit value based on the stack temperature and the water content; and controls the current limiting circuit to limit the output current to the limit value or less after the warm-up is completed.

### BRIEF DESCRIPTION OF THE DRAWINGS

The objects, features, and advantages of the present invention will become clearer from the following description of embodiments in relation to the attached drawings, in which:

FIG. 1 is a diagram schematically illustrating an example of an overall configuration of a fuel cell system according to an embodiment of the present invention;

FIG. 2 is a block diagram schematically illustrating an example of a control configuration of the fuel cell system according to the embodiment of the present invention;

FIG. 3 is a diagram for explaining characteristic of a limit value set by a current limitation unit in FIG. 2; and

FIG. 4 is a flowchart illustrating an example of processing executed by an electronic control unit in FIG. 2.

### DETAILED DESCRIPTION OF THE INVENTION

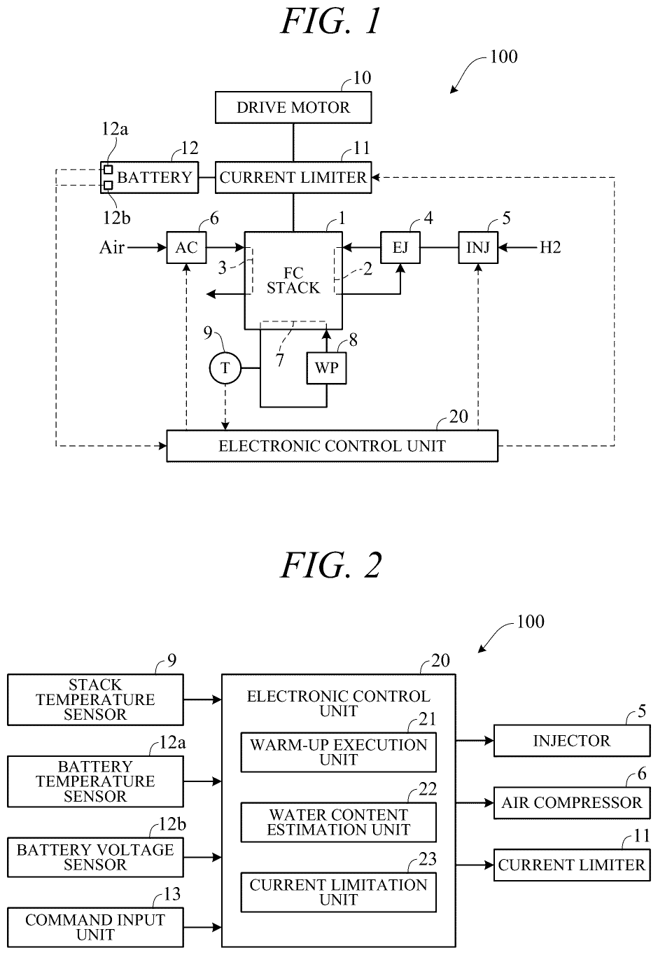

Hereinafter, embodiments of the present invention will be described with reference to FIGS. 1 to 4. FIG. 1 is a diagram schematically illustrating an example of an overall configuration of a fuel cell system 100 according to an embodiment of the present invention. As illustrated in FIG. 1, the fuel cell system 100 mainly includes a fuel cell stack 1 formed by stacking power generation cells, and an electronic control unit 20 that controls each unit of the fuel cell system 100. Each power generation cell of the fuel cell stack 1 has a membrane electrode assembly (MEA) in which electrodes (such as an electrode catalyst layer and a gas diffusion layer) are provided on both surfaces of a solid polymer electrolyte membrane. The fuel cell system 100 is mounted on a vehicle, for example, and can generate electric power for driving the vehicle. The fuel cell system 100 can be mounted on a moving body, such as an aircraft or a ship, other than a vehicle, a robot, or various types of industrial machine.

A fuel gas containing hydrogen is supplied to an anode electrode of each power generation cell of the fuel cell stack 1 through an anode flow path 2, and an oxidant gas such as air containing oxygen is supplied to a cathode electrode through a cathode flow path 3. Accordingly, an electrochemical reaction proceeds in the electrode of each power generation cell, and power generation is performed in the fuel cell stack 1.

A fuel gas tank storing high-pressure fuel gas is connected to the anode flow path 2 via an ejector 4 and an injector 5, and the fuel gas in the fuel gas tank is supplied to the anode flow path 2. The fuel gas supplied to the anode flow path 2 is partially used by the anode electrode, and then discharged from the anode flow path 2 as a fuel exhaust gas. The fuel exhaust gas discharged from the anode flow path 2 is sucked through the ejector 4 after water is separated through a gas-liquid separator (not illustrated), and is supplied to the anode flow path 2 again.

An air compressor 6 for supplying an oxidant gas is connected to the cathode flow path 3, and the oxidant gas compressed by the air compressor 6 is supplied to the cathode flow path 3. The oxidant gas supplied to the cathode flow path 3 is partially used in the cathode electrode, and then discharged from the cathode flow path 3 to the outside as an oxidant exhaust gas.

A cooling flow path 7 through which a cooling medium circulates is also provided inside the fuel cell stack 1. A water pump 8 that circulates the cooling medium through a radiator (not illustrated) is connected to the cooling flow path 7. A stack temperature sensor 9 is provided near the outlet of the cooling flow path 7 and detects the temperature of the cooling medium discharged from the cooling flow path 7. Since the temperature of the cooling medium discharged from the cooling flow path 7 represents the overall internal temperature (stack temperature) of the fuel cell stack 1, the stack temperature sensor 9 can detect the stack temperature from the temperature of the cooling medium discharged from the cooling flow path 7.

The fuel cell stack 1 is electrically connected to a drive motor (motor generator) 10 via metal terminal plates sandwiching the stacked body of the power generation cells. A current limiter (current limiting circuit) 11 is interposed between the fuel cell stack 1 and the drive motor 10, and the electric power generated by the fuel cell stack 1 is supplied to the drive motor 10 via the current limiter 11. The current limiter 11 limits a magnitude (current value) of an output current output from the fuel cell stack 1 to a predetermined limit value or less.

A battery 12 can be electrically connected to the current limiter 11 via a DC/DC converter (not illustrated). In this case, a part or all of the electric power generated by the fuel cell stack 1 can be stored in the battery 12 through the current limiter 11. In addition, the electric energy generated by the drive motor 10 for vehicle traveling at the time of regenerative braking of the vehicle can be stored in the battery 12 via the current limiter 11. In addition, the electric power stored in the battery 12 can be supplied to the drive motor 10 via the current limiter 11 as necessary.

The battery 12 is provided with a battery temperature sensor 12a that detects the temperature (battery temperature) of the battery 12 and a battery voltage sensor 12b that detects the voltage (battery voltage) of the battery 12. A state of charge (SOC) of the battery 12 can be estimated on the basis of the battery voltage detected by the battery voltage sensor 12b.

FIG. 2 is a block diagram schematically illustrating an example of a control configuration of the fuel cell system 100. The electronic control unit 20 of the fuel cell system 100 includes a computer having a CPU, a RAM, a ROM, an I/O interface, and other peripheral circuits. As illustrated in FIGS. 1 and 2, sensors such as the stack temperature sensor 9, the battery temperature sensor 12a, and the battery voltage sensor 12b are connected to the electronic control unit 20, and a detection value is input from each sensor to the electronic control unit 20. In addition, each unit of the fuel cell system 100 such as the injector 5, the air compressor 6, and the current limiter 11 is connected to the electronic control unit 20, and the electronic control unit 20 controls each unit of the fuel cell system 100.

As illustrated in FIG. 2, the electronic control unit 20 is also connected to a command input unit 13 that inputs various commands such as startup and request output of the fuel cell system 100. The command input unit 13 includes, for example, an ignition switch, an accelerator opening sensor, and the like of a vehicle using the drive motor 10 as a traveling drive source. When a startup command of the fuel cell system 100 is input from the command input unit 13, the electronic control unit 20 controls the injector 5 and the air compressor 6 to supply the fuel gas and the oxidant gas to the fuel cell stack 1 so that the fuel cell stack 1 generates power. In addition, the electronic control unit 20 calculates the flow rates of the fuel gas and the oxidant gas to be supplied to the fuel cell stack 1 on the basis of the detection value of each sensor and the request output input from the command input unit 13, and controls the injector 5 and the air compressor 6 according to the calculation result. In addition, the electronic control unit 20 calculates a limit value of the output current from the fuel cell stack 1 on the basis of the detection value of each sensor, and controls the current limiter 11 according to the calculation result.

As illustrated in FIG. 2, the electronic control unit 20 includes a warm-up execution unit 21, a water content estimation unit 22, and a current limitation unit 23 as functional configurations, and functions as the warm-up execution unit 21, the water content estimation unit 22, and the current limitation unit 23.

The warm-up execution unit 21 executes the warm-up of the fuel cell stack 1 at the time of low-temperature startup in which the fuel cell stack 1 is started from a predetermined low-temperature state. The predetermined low-temperature state is a state in which the stack temperature detected by the stack temperature sensor 9 is equal to or lower than a temperature requiring warm-up. An outside air temperature sensor that detects an environmental temperature around the fuel cell stack 1, for example, an outside air temperature may be provided, and a state in which the outside air temperature detected by the outside air temperature sensor is equal to or lower than the temperature requiring warm-up may be set as a predetermined low-temperature state. In particular, under a freezing point, the water generated in each power generation cell of the fuel cell stack 1 may be frozen. Therefore, in a case where the stack temperature or the outside air temperature is below the freezing point, the warm-up of the fuel cell stack 1 is performed until the stack temperature is raised to at least 0° C. or more. However, the predetermined low-temperature state includes not only a state in which the stack temperature or the outside air temperature is below the freezing point, but also a state in which the temperature is equal to or lower than a temperature that requires warm-up even if the temperature is, for example, 0° C. or higher.

When the startup command of the fuel cell system 100 is input from the command input unit 13, the warm-up execution unit 21 determines whether or not the stack temperature detected by the stack temperature sensor 9 (or the outside air temperature detected by the outside air temperature sensor) is equal to or lower than the temperature requiring warm-up. The warm-up execution unit 21 executes the warm-up of the fuel cell stack 1 in a case where the stack temperature is equal to or lower than the temperature requiring warm-up, and does not execute the warm-up of the fuel cell stack 1 in a case where when the stack temperature exceeds the temperature requiring warm-up.

In a case where the warm-up of the fuel cell stack 1 is executed, the warm-up execution unit 21 sets a stack temperature (warm-up completion temperature) for ending the warm-up or a time (warm-up time) for executing the warm-up on the basis of the stack temperature detected by the stack temperature sensor 9 at the start of warm-up.

The warm-up completion temperature is set to at least 0° C. or more according to the stack temperature at the start of warm-up. The characteristic of the appropriate warm-up completion temperature according to the stack temperature at the start of warm-up are determined in advance by a test and stored in the electronic control unit 20 (ROM). The lower the stack temperature at the start of warm-up, the higher the appropriate warm-up completion temperature is set. More specifically, when the stack temperature at the start of warm-up is a relatively low temperature (for example, about −30° C.) even under the freezing point, the warm-up completion temperature is set to a relatively high temperature (for example, about 50° C.) close to the stack temperature (for example, about 50° C. to 90° C.) during the normal operation of the fuel cell stack 1. On the other hand, when the stack temperature at the start of warm-up is a relatively high temperature (for example, about −10° C. to −5° C.) even under the freezing point, the warm-up completion temperature is set to a relatively low temperature (for example, about 20° C. to 30° C.) exceeding 0° C.

The appropriate warm-up time according to the stack temperature at the start of warm-up is a time required for raising the temperature of the fuel cell stack 1 from the stack temperature at the start of warm-up to the corresponding warm-up completion temperature. The characteristic of the appropriate warm-up time according to the stack temperature at the start of warm-up can also be determined in advance by a test and stored in the electronic control unit 20. Both the characteristic of the appropriate warm-up completion temperature according to the stack temperature at the start of warm-up and the characteristic of the appropriate warm-up time according to the stack temperature at the start of warm-up may be stored in the electronic control unit 20, or only one of them may be stored in the electronic control unit 20.

The warm-up execution unit 21 sets the warm-up completion temperature or the warm-up time on the basis of the stack temperature at the start of warm-up and the characteristic stored in the electronic control unit 20, and executes the warm-up of the fuel cell stack 1 until the warm-up time or the stack temperature reaches the warm-up completion temperature.

The warm-up of the fuel cell stack 1 is executed as, for example, low-efficiency power generation in which the supply amount of the oxidant gas to the cathode flow path 3 is reduced as compared with that during the normal operation (normal power generation) of the fuel cell stack 1. In the low-efficiency power generation, the supply amount of the oxidant gas to the cathode flow path 3 is reduced as compared with that during the normal operation, and a ratio (air stoichiometric ratio) of the air supply amount to the theoretical air consumption amount necessary for power generation (electrochemical reaction) in the fuel cell stack 1 is reduced as compared with that during the normal operation. In this case, since an oxygen concentration at the interface of the cathode electrode is lower compared with that during the normal operation, in order to maintain the current value, it is necessary to increase a probability that electrons are exchanged between the cathode electrode and oxygen by consuming a voltage (concentration overvoltage). This concentration overvoltage causes the output voltage to be lower compared with that during the normal operation, resulting in low-efficiency power generation in which the output voltage is lower compared with the IV characteristic (reference IV characteristic) during the normal operation, and a power generation loss increases compared with that during the normal operation. Since the power generation loss is converted into thermal energy to raise the temperature of the fuel cell stack 1, the temperature of the fuel cell stack 1 can be raised more quickly than during the normal operation by performing the low-efficiency power generation.

In a case where the warm-up of the fuel cell stack 1 is executed, the warm-up execution unit 21 controls the injector 5 and the air compressor 6 to supply the fuel gas and the oxidant gas to the fuel cell stack 1, so that the air stoichiometric ratio is lowered and the low-efficiency power generation is performed in the fuel cell stack 1. A heater may be provided around the fuel cell stack 1, and the warm-up of the fuel cell stack 1 may be executed by the heater in addition to the low-efficiency power generation.

The water content estimation unit 22 estimates the water content of each power generation cell (mainly MEA) on the basis of an operation history of the fuel cell stack 1. The operation history includes, for example, a current value, a stack temperature, and an operation time at the time of the previous operation stop of the fuel cell stack 1, whether or not warm-up, scavenging, or drainage of each of the flow paths 2 and 3 has been performed after the previous operation stop, an elapsed time from the time of the previous operation stop to the time of the current startup, a stack temperature at the time of the current startup, an outside air temperature, and the like. Since each of the flow paths 2 and 3 is sealed during the operation stop of the fuel cell stack 1, the water content at the time of the current startup can be accurately estimated on the basis of the operation history from the time of the previous operation stop to the time of the current startup. In addition, in a case where the water content is estimated on the basis of the operation history of the fuel cell stack 1, unlike a case where the water content is estimated on the basis of the resistance of the power generation cell, it is not necessary to provide an additional type of sensor such as an impedance sensor, so that the configuration of the whole system can be simplified.

When the warm-up is completed by the warm-up execution unit 21, the current limitation unit 23 controls the current limiter 11 to perform the output current limitation of limiting the output current output from the fuel cell stack 1 to the limit value or less for a predetermined time (for example, about 15 seconds) from the time point the warm-up is completed. When the warm-up of the fuel cell stack 1 is completed, the supply amounts of the fuel gas and the oxidant gas are calculated according to the reference IV characteristic so as to satisfy the required output input from command input unit 13, and the injector 5 and the air compressor 6 are controlled according to the calculation result. In a case where the fuel cell stack 1 has not reached the stack temperature (for example, about 50° C. to 90° C.) during the normal operation at the time of completion of the warm-up, when a relatively large output is required immediately after the completion of the warm-up, the output voltage may decrease due to flooding, and a power generation state may become unstable.

That is, in a state where the stack temperature is low and a saturated water vapor pressure is low, water generated by power generation (electrochemical reaction) in the fuel cell stack 1 is not appropriately discharged, which may cause flooding that water stagnates at the interface of the cathode electrode. In this case, the electrochemical reaction is delayed due to the insufficient oxygen concentration at the interface of the cathode electrode, the output voltage rapidly decreases, the operation with the reference IV characteristic becomes impossible, and the power generation state becomes unstable. In particular, in a case where the warm-up of the fuel cell stack 1 is performed by low-efficiency power generation, water is generated even during warm-up with a low stack temperature, and thus flooding is likely to occur.

The current limitation unit 23 sets a limit value on the basis of the stack temperature detected by the stack temperature sensor 9 and the water content estimated by the water content estimation unit 22, and limits the output current from the fuel cell stack 1 to the limit value or less. The limit value is determined in advance by a test as a maximum current value in a range in which a decrease in output voltage due to flooding does not occur according to the stack temperature and the water content. The characteristic of the limit value according to the stack temperature and the water content is stored in the electronic control unit 20 (ROM).

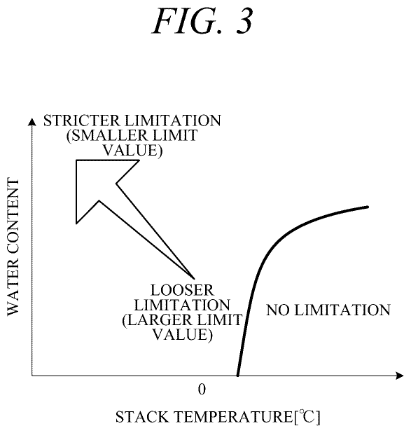

FIG. 3 is a diagram for explaining the characteristic of the limit value set by the current limitation unit 23. As illustrated in FIG. 3, the limit value is set as a smaller current value as the stack temperature decreases (that is, the lower the stack temperature, the stricter the output current limitation is set), and is set as a smaller current value as the water content increases (that is, the higher the water content, the stricter the output current limitation is set). After the completion of the warm-up, after the stack temperature reaches the stack temperature (for example, about 50° C. to 90° C.) during the normal operation of the fuel cell stack 1, the decrease in output voltage due to flooding does not occur as long as the operation according to the reference IV characteristic is performed, and it is not necessary to perform the output current limitation. After the completion of the warm-up, until the stack temperature reaches the stack temperature during the normal operation, the decrease in output voltage due to flooding may occur depending on the amount of water present inside the fuel cell stack 1. In such a region, it is possible to suppress the decrease in output voltage due to flooding by setting the limit value according to the stack temperature and the water content and performing the output current limitation. When a maximum current value in a range in which the decrease in output voltage due to flooding does not occur is set as the limit value according to the stack temperature and the water content, excessive output limitation can be suppressed, and the output performance of the fuel cell stack 1 can be secured.

Even if the stack temperature after the completion of the warm-up is relatively low at the time of completion of the warm-up, the stack temperature gradually increases with the operation of the fuel cell stack 1, and, after a predetermined time (for example, about 15 seconds), reaches a temperature range during the normal operation in which there is no possibility of the decrease in output voltage due to flooding. When a predetermined time elapses from a time point when the warm-up by the warm-up execution unit 21 is completed, the current limitation unit 23 ends (releases) the output current limitation and controls the current limiter 11 to perform the normal operation according to the reference IV characteristic of the fuel cell stack 1. In this way, by ending the output current limitation in a necessary and sufficient predetermined time, excessive output limitation can be suppressed, and the output performance of the fuel cell stack 1 can be secured.

During the output current limitation by the current limitation unit 23, the request output input from the command input unit 13 may not be satisfied. In this case, the electric power from the battery 12 may be supplied to the drive motor 10 on condition that the SOC based on the battery temperature detected by the battery temperature sensor 12a and the battery voltage detected by the battery voltage sensor 12b is equal to or larger than a predetermined threshold.

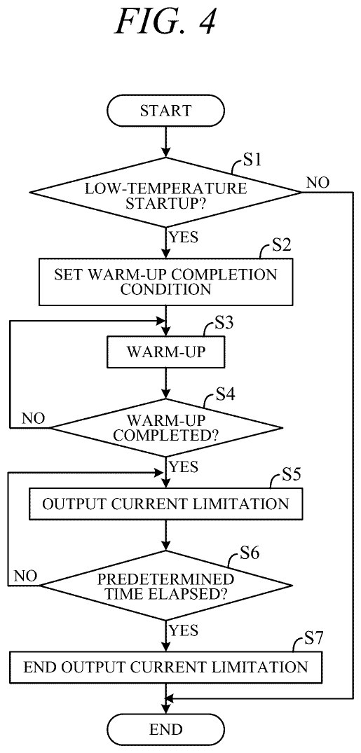

FIG. 4 is a flowchart illustrating an example of processing executed by the electronic control unit 20. The processing of FIG. 4 starts when a startup command of the fuel cell system 100 is input from the command input unit 13. As illustrated in FIG. 4, first, in S1 (S: processing step), it is determined whether or not the stack temperature detected by the stack temperature sensor 9 is equal to or lower than the temperature requiring warm-up. In a case where the determination is negative in S1, the processing ends, and when the determination is positive in S1, the processing proceeds to S2. In S2, a warm-up completion condition (warm-up completion temperature or warm-up time) is set on the basis of the stack temperature detected by stack temperature sensor 9 in S1, and the processing proceeds to S3 to start the warm-up of the fuel cell stack 1. Next, in S4, it is determined whether or not the warm-up completion condition set in S2 is satisfied. In a case where the determination is negative in S4, the processing returns to S3 to continue the warm-up of the fuel cell stack 1, and in a case where the determination is positive in S4, the warm-up is ended, and the processing proceeds to S5.

In S5, a limit value is set on the basis of the stack temperature detected by the stack temperature sensor 9 and the water content estimated by the water content estimation unit 22, and the output current limitation is started. Next, in S6, it is determined whether or not a predetermined time has elapsed from the warm-up completion (the start of the output current limitation). In a case where the determination is negative in S6, the processing returns to S5 to continue the output current limitation, and in a case where the determination is positive in S6, the processing proceeds to S7 to end (cancel) the output current limitation, and the processing ends. When the processing in FIG. 4 is completed, the fuel cell stack 1 shifts to the normal operation according to the reference IV characteristic of the fuel cell stack 1.

According to the present embodiment, the following operations and effects can be achieved.

(1) The fuel cell system 100 includes: the fuel cell stack 1 that is configured by stacking power generation cells each having an electrolyte membrane and an electrode; the stack temperature sensor 9 that detects a temperature (stack temperature) of the fuel cell stack 1; the warm-up execution unit 21 that executes warm-up of the fuel cell stack 1 at time of low-temperature startup in which the fuel cell stack 1 is started from a predetermined low-temperature state; the water content estimation unit 22 that estimates a water content of the power generation cell; and the current limitation unit 23 that limits an output current output from the fuel cell stack 1 to a limit value or less (FIGS. 1 and 2). The current limitation unit 23 sets the limit value on the basis of the stack temperature detected by the stack temperature sensor 9 and the water content estimated by the water content estimation unit 22, and limits the output current to the limit value or less after the warm-up by the warm-up execution unit 21 is completed (S5 to S7 in FIGS. 3 and 4).

When output current limitation is performed after completion of the warm-up of the fuel cell stack 1 in this manner, it is possible to suppress a decrease in output voltage due to flooding even in a case where a relatively large output is required immediately after the completion of the warm-up. In addition, when the limit value is set on the basis of the stack temperature and the water content, an appropriate limit value can be accurately set. In addition, when a maximum current value in a range in which the decrease in output voltage due to flooding does not occur is set as the limit value according to the stack temperature and the water content, excessive output limitation can be suppressed, and the output performance of the fuel cell stack 1 can be secured.

(2) The limit value is set to be smaller as the stack temperature decreases and smaller as the water content increases (FIG. 3). When relatively large output is required at a stage where the stack temperature immediately after the completion of warm-up of the fuel cell stack 1 is relatively low, flooding may occur depending on an amount of water present inside the fuel cell stack 1, and the output voltage output from the stack may decrease. After the completion of warm-up of the fuel cell stack 1, necessary and sufficient output current limitation is performed on the basis of the stack temperature and the water content, it is possible to suppress the decrease in output voltage due to flooding while securing the output performance of the fuel cell stack 1.

(3) The current limitation unit 23 limits the output current to the limit value or less for a predetermined time from a time point when the warm-up by the warm-up execution unit 21 is completed (S5 to S7 in FIG. 4). Even if the stack temperature is relatively low at the time of completion of the warm-up, the stack temperature gradually increases with an operation of the fuel cell stack 1, and thus, after a predetermined time, reaches a temperature range during the normal operation in which there is no possibility of the decrease in output voltage due to flooding. By ending the output current limitation in such a predetermined time, excessive output limitation can be suppressed, and the output performance of the fuel cell stack 1 can be secured.

(4) The warm-up execution unit 21 sets a warm-up time or a warm-up completion temperature on the basis of the stack temperature detected at the start of warm-up, and executes the warm-up of the fuel cell stack 1 until the warm-up time elapses or until the stack temperature reaches the warm-up completion temperature (S3 to S4 in FIG. 4). By setting an appropriate warm-up time or warm-up completion temperature according to the stack temperature at the start of warm-up, it is possible to minimize a decrease in energy efficiency due to the warm-up involving power generation loss.

(5) The warm-up completion temperature is set to 0° C. or more, and the warm-up time is set such that the stack temperature detected at the time of completion of the warm-up is 0° C. or more. In a predetermined low-temperature state in which an outside air temperature or the stack temperature is equal to or lower than a temperature requiring warm-up, water generated in each power generation cell of the fuel cell stack 1 may be frozen. Therefore, in a case where the outside air temperature or the stack temperature is equal to or lower than the temperature requiring warm-up, the warm-up of the fuel cell stack 1 is performed until the stack temperature is raised to at least 0° C. or higher.

In the above embodiment, an example has been described in which a temperature of a cooling medium discharged from the cooling flow path 7 is detected as the stack temperature in FIG. 1 and the like, but a physical quantity representing the temperature of the fuel cell stack is not limited to such an example. For example, a temperature of an oxidant exhaust gas discharged from the cathode flow path 3 may be detected as the physical quantity representing the temperature of the fuel cell stack, or the temperature of the fuel cell stack 1 itself (for example, each power generation cell) may be detected.

In the above embodiment, an example has been described in which the water content is estimated on the basis of an operation history of the fuel cell stack 1 in FIG. 3 and the like, and the limit value of the output current limitation is set according to the stack temperature and the water content, but the characteristic for setting the limit value is not limited to such an example. That is, the limit value, which is the maximum current value in the range in which the decrease in output voltage due to flooding does not occur, changes according to the amount of water present inside the fuel cell stack 1, more specifically, on the cathode side and the stack temperature. Such an amount of water changes according to the operation history of the fuel cell stack 1 from a time of operation stop to a time of operation startup. In addition, the water content of the power generation cell (mainly MEA), a relative humidity of the oxidant exhaust gas discharged from the cathode flow path 3, and the like change according to the amount of water. Therefore, the characteristic of the limit value may be determined on the basis of the relative humidity of the oxidant exhaust gas discharged from the cathode flow path 3 and the stack temperature. Alternatively, the characteristic of the limit value according to the stack temperature may be determined for each pattern of the operation history of the fuel cell stack 1 such as the presence or absence of scavenging or drainage from the time of operation stop to the time of operation startup.

The above embodiment can be combined as desired with one or more of the aforesaid modifications. The modifications can also be combined with one another.

According to the present invention, it becomes possible to suppress decrease in the output voltage due to flooding.

Above, while the present invention has been described with reference to the preferred embodiments thereof, it will be understood, by those skilled in the art, that various changes and modifications may be made thereto without departing from the scope of the appended claims.

1. A fuel cell system, comprising:
a fuel cell stack configured by stacking a power generation cell including an electrolyte membrane and an electrode;
a temperature sensor configured to detect a stack temperature of the fuel cell stack;
a current limiting circuit configured to limit an output current output from the fuel cell stack to a limit value or less; and
an electronic control unit, wherein
the electronic control unit:
executes warm-up of the fuel cell stack at time of low-temperature startup in which the fuel cell stack is started from a predetermined low-temperature state;
estimates a water content of the power generation cell;
sets the limit value based on the stack temperature and the water content; and
controls the current limiting circuit to limit the output current to the limit value or less after the warm-up is completed.

2. The fuel cell system according to claim 1, wherein
the limit value is set to be smaller as the stack temperature decreases and smaller as the water content increases.

3. The fuel cell system according to claim 1, wherein
the electronic control unit controls the current limiting circuit to limit the output current to the limit value or less for a predetermined time from a time point when the warm-up is completed.

4. The fuel cell system according to claim 1, wherein
the electronic control unit sets a warm-up time or a warm-up completion temperature based on the stack temperature detected at a start of the warm-up, and executes the warm-up until the warm-up time elapses or until the stack temperature reaches the warm-up completion temperature.

5. The fuel cell system according to claim 4, wherein
the warm-up completion temperature is set to 0° C. or more, wherein
the warm-up time is set such that the stack temperature detected at a time of completion of the warm-up is 0° C. or more.

6. The fuel cell system according to claim 1, wherein
the warm-up is executed as a low-efficiency power generation.

7. The fuel cell system according to claim 6, wherein
in the fuel cell stack, an electrochemical reaction of fuel gas containing hydrogen supplied to the fuel cell stack and oxidant gas containing oxygen supplied to the fuel cell stack proceeds in electrodes of the fuel cell stack, and power generation is performed, wherein
in the low-efficiency power generation, an amount of the oxidant gas supplied to the fuel cell stack is reduced as compared with that in a normal power generation.
